(19) United States
(12) Patent Application Publication
(10) Pub. No.: US 2026/0128900 A1
(43) Pub. Date: May 7, 2026

(54) BIOMETRICALLY PROTECTED BACKGROUND TASKS

(71) Applicant: CyberArk Software Ltd., Petach-Tikva (IL)

(72) Inventors: Tal Zigman, Ness Ziona (IL); Yonatan Lozinsky, Or Akiva (IL); Arthur Bendersky, Tel-Aviv (IL)

(73) Assignee: CyberArk Software Ltd., Ptach-Tikva (IL)

(21) Appl. No.: 19/381,507

(22) Filed: Nov. 6, 2025

Related U.S. Application Data
(60) Provisional application No. 63/717,371, filed on Nov. 7, 2024.

(51) Int. Cl. H04L 9/32; H04L 9/08

(52) U.S. Cl. CPC H04L 9/3231; H04L 9/0825; H04L 9/0866

(57) ABSTRACT

Disclosed embodiments relate to non-transitory computer readable media, systems, and methods for biometrically securing application tasks. Techniques include identifying, by the application, a cryptographic key. Techniques further include prompting an encryption mechanism operated by an operating system to encrypt the cryptographic key using the biometrically protected key. Techniques further include storing the encrypted cryptographic key in a memory location. Techniques further include in a non-active state of the application, using the unencrypted cryptographic key to encrypt data or to ensure authenticity or integrity of data. Techniques further include upon a change of state of the application to an active state, performing at least one of: using the unencrypted cryptographic key or prompting the operating system to decrypt the encrypted cryptographic key using the biometrically protected key. Techniques further include using the decrypted cryptographic key to decrypt the encrypted data or to validate the signature.

### CROSS REFERENCES TO RELATED APPLICATIONS

This application claims the benefit of priority from U.S. Provisional Patent Application No. 63/717,371, filed November 7, 2024, the entire contents of which are incorporated herein by reference. The foregoing application is incorporated herein by reference in its entirety.

### TECHNICAL FIELD

The present disclosure relates generally to application security, and more particularly to systems, methods, and computer-readable media storing instructions for enabling biometrically protected background tasks on computing devices.

### BACKGROUND

Mobile applications (e.g., running on smartphones, tablets, and the like) may use biometric authentication mechanisms to secure cryptographic keys. Due to the interactive nature of biometric authentication, these keys are typically protected by hardware security features and cannot be accessed or utilized when the application is in the background. This limits the application’s ability to perform secure operations during background execution.

In one exemplary scenario, an organization may maintain offline accounts (e.g., accounts stored in mobile phone memory, and not requiring a network connection). Users may need to access such accounts in “break glass” situations, such as network outages or the like. For example, the CyberArk® Mobile Application securely stores critical offline credentials on users’ mobile devices, which they can access in case of a shutdown or unreachable network. Syncing these accounts may involve the user opening the app and triggering the sync process. The sync process may also take an undesirable length of time.

This process may be insufficient for customers, as accounts are synced only when opening the application. Users may want the sync to take place without user interaction. In such situations, users may desire to access application credentials despite a lack of network connectivity. To address such a scenario, offline account ID’s (but not, in some embodiments, passwords) per-tenant may be stored on a service (e.g., offline accounts service). Using such a service, a silent push notification may be periodically (e.g., every thirty minutes or every three hours, etc.) sent to try to sync credentials with an application. With each push notification, a fetch “synch request” may be sent from the mobile application to the offline accounts service. For each tenant, the offline accounts service may have the account ID’s to retry and the last sync timestamp. In the case of a success or failure, the mobile application may send a “confirmation” message and metadata to the offline accounts service. If an account fails, a retry may be performed (e.g., 30 minutes later).

In this exemplary use case, various technical challenges arise when seeking to secure the background performance of mobile tasks. For example, one challenge relates to sending signed requests to a mobile-API-service while the mobile device is locked. The mobile device may have hardware security limitations that prevent signing requests while the device is locked. Another problem relates to encrypting credentials while the device is locked. A further problem may relate to maintaining a reasonable interval of time between synchs. Further, existing approaches for securing mobile applications use other authentication methods that do not have biometric protection. This lowers the security level of the background tasks and the overall solution.

In the context of the present disclosure and the exemplary cases, additional technical challenges that may be faced relate to the interval between data being received and stored in a secure form (e.g., synchronization of stored credentials). There is no guarantee that the data management application will wake up at a certain time. Apple™ devices, for example, do not provide a way to guarantee that an application will become active and be able to access a biometrically protected key. The time range before an application becomes active can vary greatly (e.g., between becoming active immediately to 8-hour delays). The sooner the application finishes background tasks, the higher priority it is given for waking up in the background. Apple™ penalizes sending silent pushes too frequently (e.g., more than 2-3 per hour), or if too much bandwidth (e.g., KBs of data sent / received) is consumed. In this context, some of the parameters are outside of the application’s control (e.g., battery percentage, usage patterns, frequency, etc.). But some can be controlled (e.g., speed and efficiency of background or active tasks, timeout settings, failing, etc.).

Another technical challenge may relate to the time limit for a background task to complete. For example, if the time limit is 30 seconds, this means there is a 30-second window to complete the necessary active functions. Also, the application may crash in the background if certain functions are not called during the 30 second window, or if they are called more than once. For example, prior systems may have performed all necessary functions in sequence: every function used in the process, delaying other functions from starting or completing.

The advantageous solutions described herein address these and other technical problems in the fields of application security, network security, and mobile communications.

### SUMMARY

The disclosed embodiments describe non-transitory computer readable media, systems, and methods for biometrically securing application tasks. For example, in an embodiment, a non-transitory, computer-readable medium may store instructions configured to perform operations for biometrically securing application tasks. The operations may comprise identifying, by the application, a cryptographic key. The operations may further comprise prompting an encryption mechanism operated by an operating system to encrypt the cryptographic key using the biometrically protected key. The operations may further comprise storing the encrypted cryptographic key in a memory location. The operations may further comprise in a non-active state of the application, using the unencrypted cryptographic key to encrypt data or to ensure authenticity or integrity of data. The operations may further comprise upon a change of state of the application to an active state, performing at least one of: using the unencrypted cryptographic key or prompting the operating system to decrypt the encrypted cryptographic key using the biometrically protected key. The operations may further comprise using the decrypted cryptographic key to decrypt the encrypted data or to validate the signature.

In an embodiment, the operations may further comprise modifying a temporary version of the encrypted cryptographic key upon the application terminating.

In an embodiment, the operations may further comprise retaining the encrypted cryptographic key on the computing device after the termination of the application.

In an embodiment, the operations may further comprise retrieving the encrypted cryptographic key upon a resumed execution of the application.

In an embodiment, the operations may further comprise retaining the encrypted data on the computing device after a termination of the application.

In an embodiment, the operations may further comprise storing a plurality of encrypted keys encrypted using one or more biometrically protected keys on the computing device, wherein each of the plurality of encrypted keys is associated with a different application on the computing device.

In an embodiment, identifying, by the application, a cryptographic key may further comprise generating an asymmetric cryptographic key pair corresponding to the biometrically protected key.

In an embodiment, identifying, by the application, a cryptographic key may further comprise generating a symmetric cryptographic key corresponding to the biometrically protected key.

In an embodiment, the operations may further comprise requesting, from an authentication mechanism on a computing device hosting an application, a reference to a biometrically protected key; wherein encrypting and decrypting the cryptographic key uses the reference; and wherein the reference to the biometrically protected key comprises a memory pointer.

In an embodiment, the active state may be a foreground state.

As an additional example, in an embodiment, there may be a computer-implemented method for biometrically securing application background tasks by performing operations. The operations may comprise identifying, by the application, a cryptographic key. The operations may further comprise prompting an encryption mechanism operated by an operating system to encrypt the cryptographic key using the biometrically protected key. The operations may further comprise storing the encrypted cryptographic key in a memory location. The operations may further comprise in a non-active state of the application, using the unencrypted cryptographic key to encrypt data or to ensure authenticity or integrity of data. The operations may further comprise upon a change of state of the application to an active state, performing at least one of: using the unencrypted cryptographic key or prompting the operating system to decrypt the encrypted cryptographic key using the biometrically protected key. The operations may further comprise using the decrypted cryptographic key to decrypt the encrypted data or to validate the signature.

In an embodiment, the cryptographic key may be a temporary key.

In an embodiment, the cryptographic key may be permanent key.

In an embodiment, the encrypted data may be stored on the computing device.

In an embodiment, the encrypted data may be stored in a location remote from the computing device.

In an embodiment, accessing the encrypted cryptographic key may be performed based on the application receiving a request.

In an embodiment, accessing the encrypted cryptographic key may be performed based on the application attempting to communicate with a server or a device.

In an embodiment, accessing the encrypted cryptographic key may be performed based on the application attempting to perform a scheduled task.

In an embodiment, accessing the encrypted cryptographic key may be performed based on a timer associated with the application.

In an embodiment, accessing the encrypted cryptographic key may be performed based on a security policy external to the application

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an example system environment for secure storage and management of secrets, consistent with the disclosed embodiments.

FIG. 2 is a block diagram showing an example computing device, consistent with the disclosed embodiments.

FIGS. 3A-3C are an exemplary process flow of a system for providing biometric authentication of background tasks, consistent with the disclosed embodiments.

FIGS. 4A-4F are a series of conceptual illustrations of a system for providing biometric authentication of background tasks, consistent with the disclosed embodiments.

FIG. 5 is an exemplary process diagram of a system for providing biometric authentication of background tasks, consistent with the disclosed embodiments.

FIG. 6 is an exemplary system for providing biometric authentication of background tasks using simultaneous processing, consistent with the disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

This disclosure provides techniques for the execution of background tasks (e.g., non-interactive actions) without requiring the user of a mobile device to complete a biometric authentication, while still providing that the tasks remain secured through biometric authentication. While some embodiments may focus on securing mobile applications and their background tasks, other disclosed embodiments pertain to various other types of endpoints and their background tasks (e.g., computing devices, IoT devices, applications, processes, virtual machines, container instances, serverless code instances, and the like).

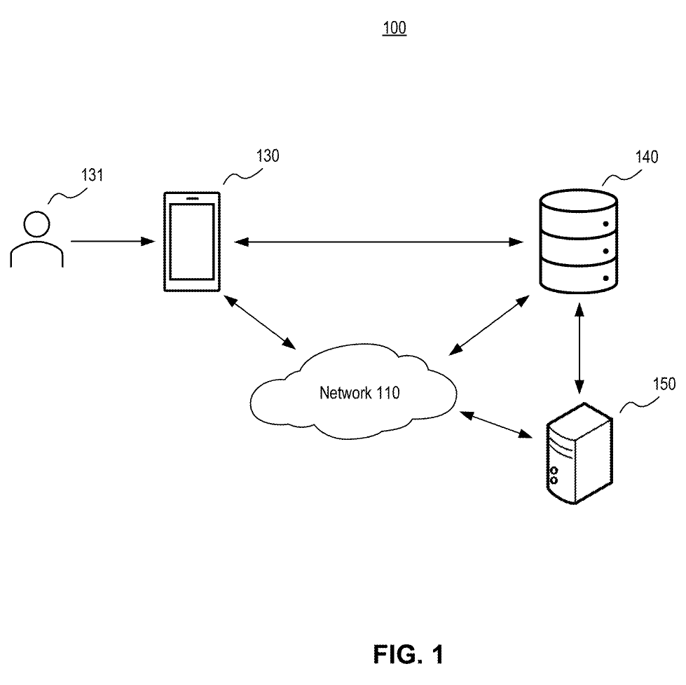

FIG. 1 illustrates an exemplary system 100 for providing biometric authentication of background tasks, consistent with the disclosed embodiments. System 100 may include one or more computing devices 130 accessible by a user 131, one or more databases 140, and one or more servers 150, as shown in FIG. 1.

The various components may communicate over network 110. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system 100 is shown as a network-based environment, it is understood that the disclosed systems and methods may also be used in a localized system, with one or more of the components communicating directly with each other.

As noted above, system environment 100 may include one or more computing devices 130. Computing device 130 may include any device that may be used for performing various computing operations as described herein. Accordingly, computing devices 130 may be a variety of different types of computing devices capable of developing, storing, analyzing, and/or executing software code. For example, computing device 130 may be a personal computer (e.g., a desktop or laptop), an IoT device (e.g., sensor, smart home appliance, connected vehicle, etc.), a server, a mainframe, a vehicle-based or aircraft-based computer, a virtual machine (e.g., virtualized computer, container instance, etc.), or the like. Computing device 130 may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 130 may operate using a mobile operating system such as iOS or Android, a Windows™ operating system, a terminal-based (e.g., Unix or Linux) operating system, a cloud-based operating system (e.g., through AWS™, Azure™, IBM Cloud™, etc.), or other types of non-terminal operating systems. In some embodiments, computing device 130 may be a virtual machine (e.g., based on AWS™, Azure™, IBM Cloud™, etc.), container instance (e.g., Docker™ container, Java™ container, Windows Server™ container, etc.), or other virtualized instance. As discussed further below, computing devices 130 may be used for executing software applications, functions, or scripts. For example, user 131 may interact with computing device 130.

System 100 may further comprise one or more database(s) 140, for storing and/or executing software or data. For example, database 140 may be configured to store software or code, such as data related to secure authentication and encryption. Database 140 may further be accessed by computing device 130, server 150, or other components of system 100 for downloading, receiving, processing, editing, or running the stored software or data. Database 140 may be any suitable combination of data storage devices, which may optionally include any type or combination of subordinate databases, load balancers, dummy servers, firewalls, back-up databases, and/or any other desired database components. In some embodiments, database 140 may be employed as a cloud service, such as a Software as a Service (SaaS) system, a Platform as a Service (PaaS) system, or Infrastructure as a Service (IaaS) system. For example, database 140 may be based on infrastructure or services of Amazon Web Services™ (AWS™), Microsoft Azure™, Google Cloud Platform™, Cisco Metapod™, Joyent™, vmWare™, or other cloud computing providers. In some embodiments, database 140 may be a remote storage location, such as a network drive or server in communication with network 110. In other embodiments database 140 may also be a local storage device, such as local memory of one or more computing devices (e.g., computing device 130) in a distributed computing environment.

System 100 may also comprise one or more server device(s) 150 in communication with network 110. Server device 150 may manage the various components in system 100. In some embodiments, server device 150 may be configured to process and manage requests or commands between computing devices 130 and/or databases 140. In embodiments where application code is accessed within system 100, server device 150 may manage various stages of the process, for example, by managing communications between computing devices 130 and databases 140 over network 110.

In some embodiments, computing device 130 may be associated with identity 131. Identity 131 may be any entity that may be associated with one or more cryptographic key pairs or privileges required to perform a computing operation. For example, identity 131 may be a user, an account, an application, a process, a service, an electronic signature, or any other entity or attribute associated with one or more components of system environment 100. In some embodiments, identity 131 may be a user requesting to perform a computing operation through computing device 110. In other embodiments, identity 131 may be a machine identity or other automated actor with access to system environment 100.

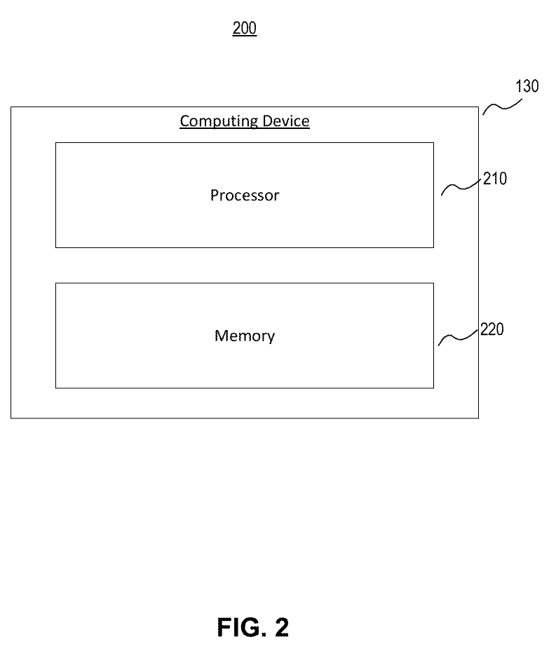

FIG. 2 is a block diagram showing an example computing device 130, consistent with the disclosed embodiments. As described above, computing device 130 may be a device configured to perform (or request to perform) one or more computing operations and may include one or more dedicated processors and/or memories. For example, computing device 130 may include a processor (or multiple processors) 210, and a memory (or multiple memories) 220, as shown in FIG. 2.

Processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. Processor 210 may also be a processor based on the ARM architecture, a processor based on the RISC-V architecture, a mobile processor, a graphics processing unit, or any other form of processor. The disclosed embodiments are not limited to any particular type of processor configured in computing device 130.

Memory 220 may include one or more storage devices configured to store instructions used by the processor 210 to perform functions related to computing device 130 described herein. The disclosed embodiments are not limited to particular software programs or devices configured to perform dedicated tasks. For example, the memory 220 may store a single program, such as a user-level application, that performs the functions associated with the disclosed embodiments, or may comprise multiple software programs. Additionally, the processor 210 may, in some embodiments, execute one or more programs (or portions thereof) remotely located from computing device 130. Furthermore, memory 220 may include one or more storage devices configured to store data for use by the programs. Memory 220 may include, but is not limited to a hard drive, a solid state drive, a CD-ROM drive, a transient or temporary storage device (e.g., a random-access memory (“RAM”)), a peripheral storage device (e.g., an external hard drive, a USB drive, etc.), a network drive, a cloud storage device, or any other storage device.

Techniques disclosed herein may involve biometric key creation and temporary key management. For example, some operations may take place in a “foreground” or active mode or state, when a mobile application is running and visible to a user (i.e., not running in the background on a mobile device). In such a state, the application may create a biometric-protected key using the device’s biometric authentication mechanism. This may include, for example, a retinal scan, fingerprint scan, or various other types of biometric scans. This key may be used for secure operations such as encryption and signing on the mobile device. For example, this key may be used in signing requests that are sent to an API and encrypting data stored on the device. On iOS™ devices, for example, the key may be managed by Secure Enclave™. Likewise, in Android™ devices, similar operations may be performed with the Trusted Execution Environment. In Windows™ and Linux environments, similar operations may be performed with the Trusted Platform Module. Various other types of encryption mechanisms may be used as well.

The application may generate a temporary key-pair (e.g., a public and private key) while running in the foreground. The private key of this temporary key pair may be encrypted using the biometric-protected key and may be stored securely in persistent storage. The public key of the temporary key pair can be sent to a backend server (e.g., SaaS) to allow actions with this key.

The disclosed techniques may also include background operations (e.g., operations performed by an application when it is not directly being accessed or manipulated by a user). In a background mode, an application may still perform tasks (e.g., sending requests or responses to network devices, receiving requests or responses from network devices, transmitting or receiving data, etc.). When a mobile application transitions to the background mode, the biometric-protected key may no longer be accessible. However, the temporary private key may remain usable. The application then may perform operations using the temporary key.

In some embodiments, any data that needs to be stored while the application is in the background state may be encrypted with the temporary key and saved to persistent storage. This provides that the data remains secure and available if the application is terminated.

Additional operations may be performed upon the mobile application terminating. In some embodiments, the terminating is simply the activity (e.g., tasks) of the application concluding or reaching a period of inactivity. In other embodiments, the mobile application terminating means that the application itself pauses or ends execution. Upon termination of the application, the temporary key pair stored in RAM may be cleared. Persistent storage may retain the encrypted temporary private key and any data encrypted with the temporary key.

In additional embodiments, foreground operations may continue. For example, when the application starts again and runs in the foreground, it may reestablish access to the biometric-protected key. The application may retrieve the encrypted temporary private key from persistent storage and decrypt it using the biometric-protected key. The application may then decrypt any data encrypted with the temporary key and perform necessary actions with the decrypted data. In some embodiments, the decrypted key (e.g., in cleartext) is not stored by the application in persistent memory, but rather only in volatile memory. As long as the unencrypted key is available to the application (e.g., the application is not terminated), the application may use that unencrypted key for its operations. But if the unencrypted key is no longer available, there is the option of asking the operating system to decrypt the stored encrypted version of the key.

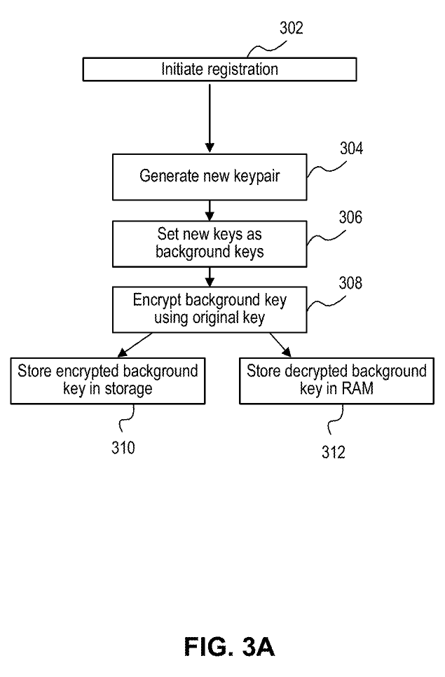

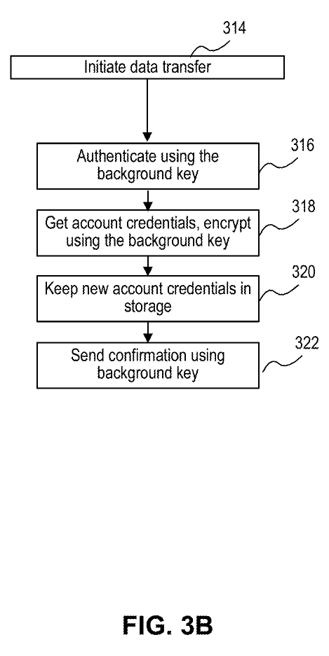

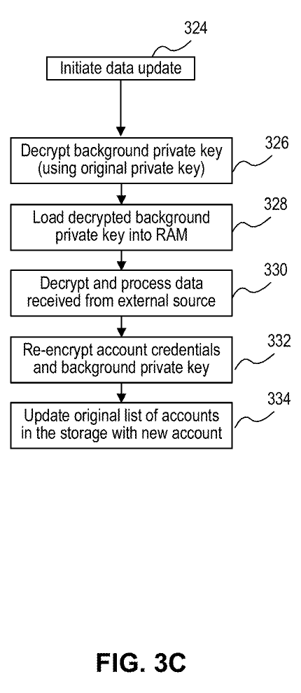

FIGS. 3A-3C are an exemplary process flow of a system for providing biometric authentication of background tasks, consistent with the disclosed embodiments. FIG. 3A is an exemplary process that may occur to register a user for authentication. At step 302, registration of a user may be initiated. For example, a user may initiate registration through an authentication application or another application on a computing device. In another example, a system may automatically initiate the registration of a user based on other triggers without user input. At step 304, the system may generate a new keypair for the user, consisting of a new public and private key. At step 306, the system may set the public key of the new key pair as a background public key and the private key of the new key pair as a background private key.

At step 308, the system may use a pre-existing key to encrypt the background private key. The pre-existing key may be a public key previously created on the computing device using biometric authentication, and requiring biometric authentication to access the corresponding pre-existing private key. For example, the pre-existing keys may be created by scanning the user’s fingerprint, and require the user to biometrically authenticate themselves with a fingerprint scan before unlocking or being able to access the pre-existing private key. In another example, the pre-existing key could be any key that can be used to encrypt the background action private key.

At step 310, the system may store the encrypted background private key in storage. In some embodiments, the storage may be local storage on the computing device. The local storage may be any appropriate storage medium. In some embodiments, the storage may be storage not local to the computing device. For example, it may be stored on a server, in cloud storage, or in any other appropriate storage medium. In some embodiments, the encrypted background private key is stored in multiple locations. At step 312, the system may store the background private key in RAM or other volatile memory accessible by applications that are currently running and/or active.

FIG. 3B is an exemplary process of receiving data while one or more applications is in a background mode. At step 314, the transfer of data from an external source may be initiated. The transfer of data may be initiated in a variety of methods. For example, the user may initiate the transfer, or the transfer may be automatically initiated by an automatic prompt, or the transfer may be initiated by a trigger based on conditions that are met. The data may be account credentials and authentication data that may provide access to a variety of applications that may be on the computing device. The data may be other secure data or any other type of data. The data may be received from an access management software on a server. At step 316, the computing device may provide the background key as authentication to the external source providing the data, to authenticate the computing device. At step 318, the computing device may receive the data from the external source, and encrypt the data using the background key. In some embodiments, the system may use the background key to ensure authenticity or integrity of data. At step 320, the computing device may store the encrypted data in storage on the computing device. At step 322, the computing device may send a confirmation to the external source using the background key.

FIG. 3C is an exemplary process of updating existing data on the computing device using the data received from an external source. At step 324, the data update is initiated. For example, a user may trigger the data update. In another example, the user may open a data management application that automatically updates all the data when the data management application is opened. In another example, the user may open an application associated with specific data, and the data update for that application may be initiated.

At step 326, the computing device may decrypt the background private key using a pre-existing key. In some embodiments, the computing device may prompt the operating system to decrypt the background private key. The pre-existing key may be a pre-existing private key that requires biometric authentication to access. At step 328, the computing device may load the decrypted background private key into RAM or other volatile memory or storage that allows the computing device to use the background private key to process the received data. At step 330, the computing device may use the decrypted background private key to decrypt the data received from the external source and process the decrypted data. For example, the decrypted data may be new account credentials associated with applications on the computing device, and stored account credentials may need to be replaced or updated with the decrypted data. In another example, the decrypted data may need to be saved, processed, stored, or otherwise used for a variety of other purposes.

At step 332, the computing device may encrypt the data and the background key using the pre-existing key and store the encrypted account credentials and the background key on the computing device. At step 334, the computing device may update a list or registry of data encrypted with the pre-existing key, based on the data that was encrypted. For example, the computing device may update a list of securely stored credentials. The stored credentials may correspond to a variety of applications that the stored credentials provide authentication or access for.

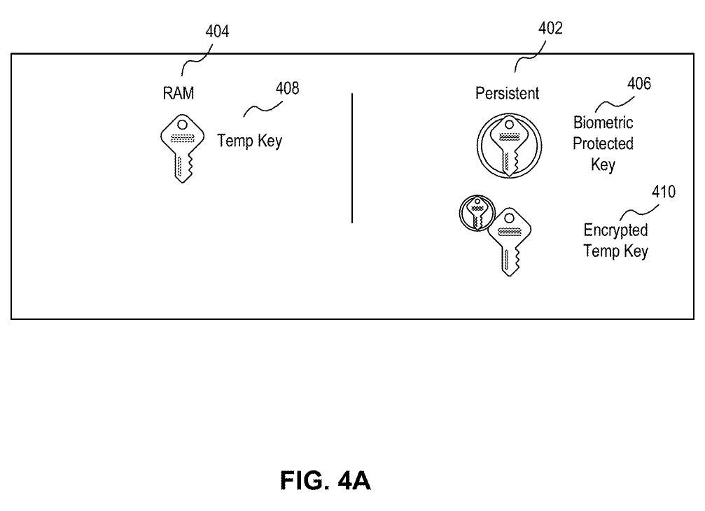

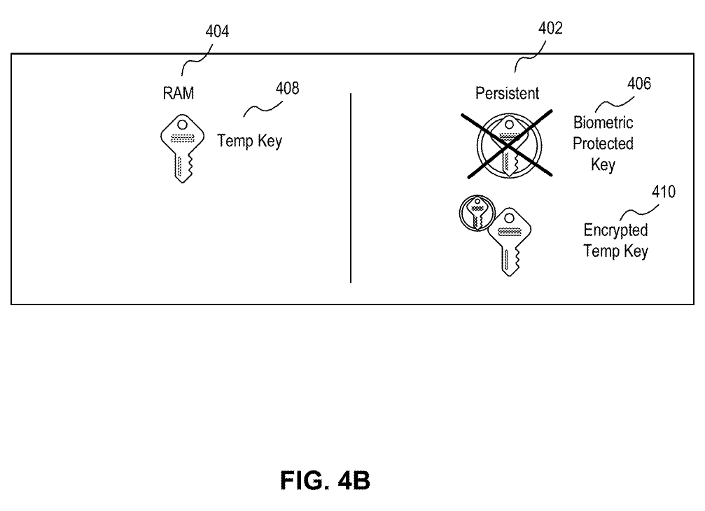

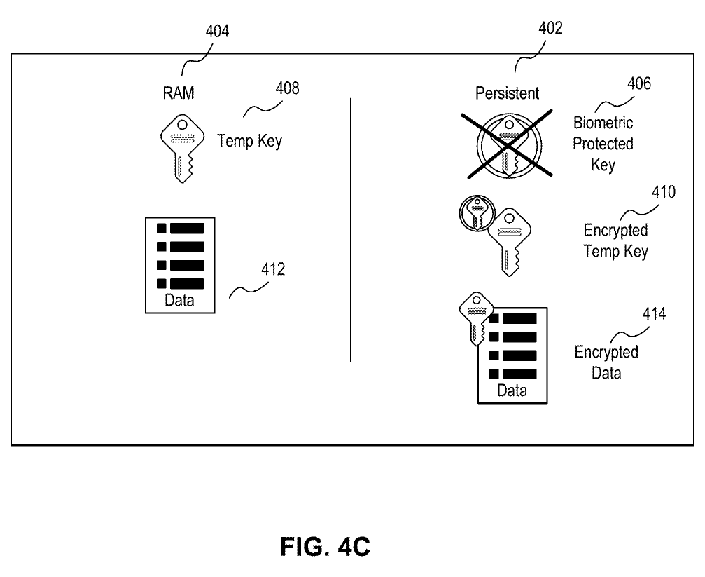

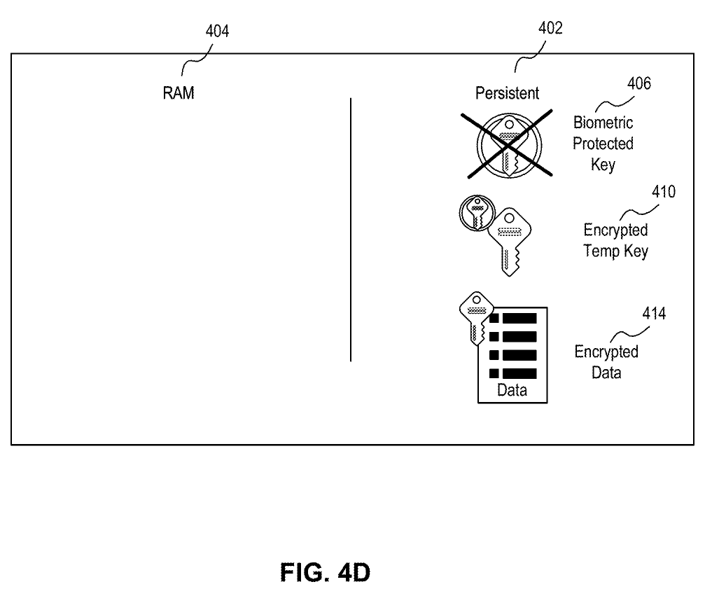

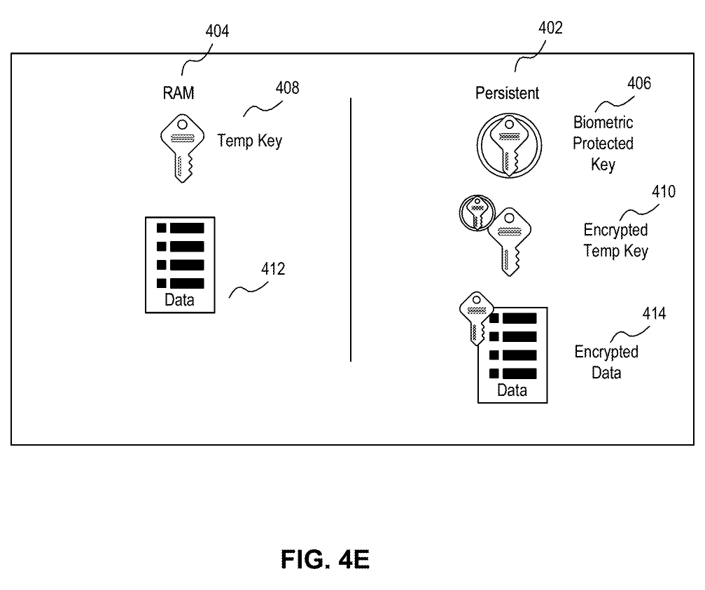

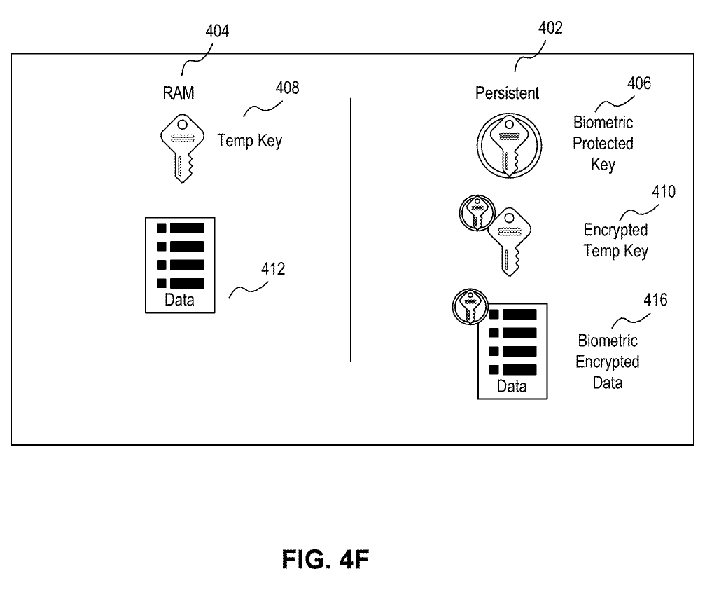

FIGS. 4A-4F are a series of conceptual illustrations of a system for providing biometric authentication of background tasks, consistent with the disclosed embodiments. FIG. 4A is an exemplary starting state of a system for providing biometric authentication of background tasks, consistent with the disclosed embodiments. The system may include a computing device that may be running a data management application that may be active in this state. The system may include persistent storage 402 such as a hard drive, and temporary storage 404 such as RAM. In some embodiments the system may use storage that is not temporary in place of temporary storage 404. The system may store a biometrically protected key 406 in the persistent storage 402. The biometrically protected key 406 may be a private key (or key-pair) that requires biometric authentication to access, such as a fingerprint scan. In some embodiments, the system may substitute other secure keys that are not biometrically protected for the biometrically protected key 406. The system may also include a temporary key 408, that is stored in temporary storage 404. The temporary key 408 may be a private key (or key pair) for use with background applications. The temporary key 408 may be associated with the data management application and may only be stored in the temporary storage 404 as long as the data management application is running.

In the active state, the data management application may have access to the biometrically protected key 406 and may be able to decrypt data using the biometrically protected key 406. The system may encrypt the temporary key 408 (or the private key of a temporary key pair), to create an encrypted temporary key 410, and may store the encrypted temporary key 410 in persistent storage 402.

FIG. 4B is an exemplary state of a system for providing biometric authentication of background tasks, consistent with the disclosed embodiments. The data management application on the computing device may be in a background state when the system is in this state. The data management application, and/or the system, may not be able to access or use the biometrically protected key 406 in this state. The system may maintain access to or use of the temporary key 408 in this state. The system may be able to perform necessary operations using the temporary key 408 including encrypting secure data.

FIG. 4C is an exemplary state of a system for providing biometric authentication of background tasks, consistent with the disclosed embodiments. The data management application on the computing device may be in a background state when the system is in this state. The system may receive or generate data 412 and store it in temporary storage 404. The data 412 may be associated with the data management application and may only be stored in the temporary storage 404 as long as the data management application is running. Data 412 may be credentials associated with applications on the computing device, for use when a user of the computing device needs to access those applications. The data may need to be stored securely, and only allow access to a user who is biometrically authenticated. The system may encrypt the data 412 with the encrypted temporary key 408 to create encrypted data 414. Encrypted data 414 may be stored in persistent storage 402. Encrypted data 414 may be accessible even if the data management application is terminated or otherwise not running. The device may require the private key of the temporary key 408 (which may also be stored as encrypted temporary key 410) to decrypt the encrypted data 414.

FIG. 4D is an exemplary state of a system for providing biometric authentication of background tasks, consistent with the disclosed embodiments. The data management application on the computing device may be terminated or otherwise not running when the system is in this state. The system may no longer store the temporary key 408 or data 412 in temporary storage 404 once the data management application is no longer running. The system may still include the encrypted data 414 stored in the persistent storage 402 even if the data management application is no longer running.

FIG. 4E is an exemplary state of a system for providing biometric authentication of background tasks, consistent with the disclosed embodiments. The data management application on the computing device may be active the system is in this state. When the data management application is active, the system may regain access to the biometrically protected key 406. The system may use the biometrically protected key 406 to decrypt the encrypted temporary key 410 to generate (in an unencrypted form) temporary key 408 and may store temporary key 408 in temporary memory 404. The system may use the temporary key 408 to decrypt the encrypted data 414 to generate (in an unencrypted form) data 412 and may store data 412 in temporary storage 404. In some embodiments, the system may use the temporary key 408 to validate the signature.

FIG. 4F is an exemplary state of a system for providing biometric authentication of background tasks, consistent with the disclosed embodiments. The data management application on the computing device may be active the system is in this state. The system may encrypt the data 412, using the biometrically protected key 406, to generate biometric encrypted data 416. Biometric encrypted data 416 may be stored in persistent storage 402. Once biometric encrypted data 416 is stored in persistent storage 402, the system may delete the unencrypted data 412. Then, the data may only be accessible when the user authenticates themselves using the biometric authentication on the computing device.

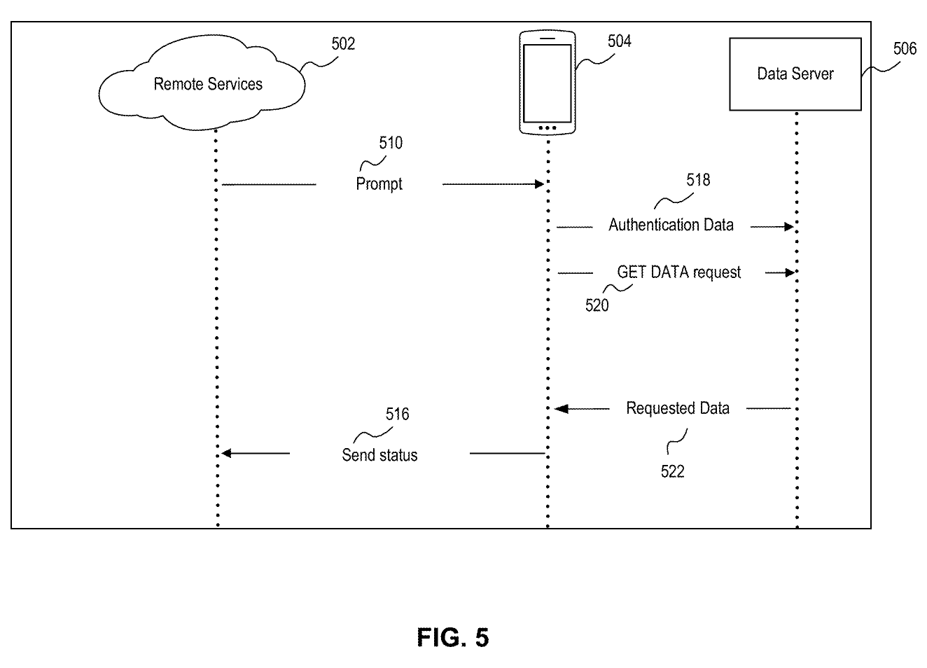

FIG. 5 is an exemplary process diagram of a system for providing biometric authentication of background tasks, consistent with the disclosed embodiments. The system may include one or more remote services (such as a centralized data management software service, e.g., one that synchronizes account credentials to mobile devices across a network) that may send a prompt 110, such as a silent push notifications, to a computing device 104 (such as a mobile device) that may include a data management application. The prompt 510 may cause the computing device 504 to run the data management application. The computing device 504 may send a GET DATA request 520 to a data server 506, and may send authentication data 518 to authenticate the computing device’s 504 access to the requested data. The data server 506 may send the requested data 522 to the computing device 504. The device may send a status 516 to the remote service 502. The status may confirm that the data was received, that processing has been performed on the data, and/or any other relevant notification.

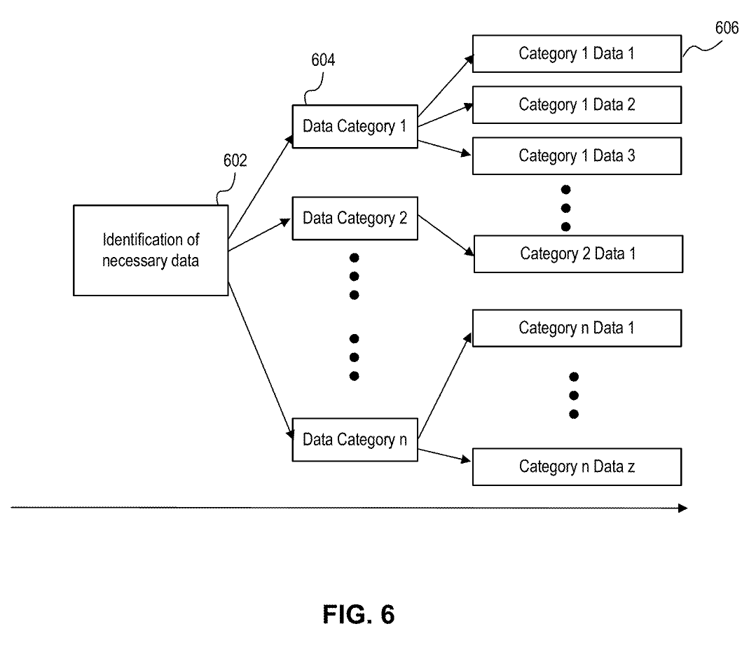

FIG. 6 illustrates an exemplary system for providing biometric authentication of background tasks using simultaneous processing, consistent with the disclosed embodiments. The system may include identifiers 602 for categories corresponding to data that is stored in an external source (for example, a list of applications on a computing device that require authentication credentials, that are stored on a credential server, or distinct identifiers stored in e.g., each application that needs to receive data such as account credentials). When a data management software establishes a connection with an external source of data, the data management software may initiate and perform one or more downloads for each category of data 604 concurrently (e.g., category 1 to category n ). Any additional steps necessary to perform the download(s) may also be initiated and performed concurrently. The system may then receive one or more data 606 corresponding to each category 604 concurrently, thereby reducing the time the data management software must run before completing the download of all the data, and any other necessary steps. While this embodiment has been described with regards to downloading data, the same description applies equally to any applicable steps or functions that the system may perform, in any combination (including authenticating data, authenticating a user, validating data, updating data, sending data, sending confirmations of other functions being completed, etc.).

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A non-transitory, computer-readable medium storing instructions configured to perform operations for biometrically securing application tasks, the operations comprising:
identifying, by the application, a cryptographic key;
prompting an encryption mechanism operated by an operating system to encrypt the cryptographic key using a biometrically protected key;
storing the encrypted cryptographic key in a memory location;
in a non-active state of the application, using the unencrypted cryptographic key to encrypt data or to ensure authenticity or integrity of data;
upon a change of state of the application to an active state, performing at least one of: using the unencrypted cryptographic key or prompting the operating system to decrypt the encrypted cryptographic key using the biometrically protected key; and
using the decrypted cryptographic key to decrypt the encrypted data or to validate the signature.

2. The computer-readable medium of claim 1, wherein the operations further comprise modifying a temporary version of the encrypted cryptographic key upon the application terminating.

3. The computer-readable medium of claim 1, wherein the operations further comprise retaining the encrypted cryptographic key on the computing device after the termination of the application.

4. The computer-readable medium of claim 3, wherein the operations further comprise retrieving the encrypted cryptographic key upon a resumed execution of the application.

5. The computer-readable medium of claim 1, wherein the operations further comprise retaining the encrypted data on the computing device after a termination of the application.

6. The computer-readable medium of claim 1, wherein the operations further comprise storing a plurality of encrypted keys encrypted using one or more biometrically protected keys on the computing device, wherein each of the plurality of encrypted keys is associated with a different application on the computing device.

7. The computer-readable medium of claim 1, wherein identifying, by the application, a cryptographic key further comprises generating an asymmetric cryptographic key pair corresponding to the biometrically protected key.

8. The computer-readable medium of claim 1, wherein identifying, by the application, a cryptographic key further comprises generating a symmetric cryptographic key corresponding to the biometrically protected key.

9. The computer-readable medium of claim 1, wherein the operations further comprise:
requesting, from an authentication mechanism on a computing device hosting an application, a reference to a biometrically protected key;
wherein encrypting and decrypting the cryptographic key uses the reference; and wherein the reference to the biometrically protected key comprises a memory pointer.

10. The computer-readable medium of claim 1, wherein the active state is a foreground state.

11. A computer-implemented method for biometrically securing application background tasks, the method comprising:
identifying, by the application, a cryptographic key;
prompting an encryption mechanism operated by an operating system to encrypt the cryptographic key using a biometrically protected key;
storing the encrypted cryptographic key in a memory location;
in a non-active state of the application, using the unencrypted cryptographic key to encrypt data or to ensure authenticity or integrity of data;
upon a change of state of the application to an active state, performing at least one of: using the unencrypted cryptographic key or prompting the operating system to decrypt the encrypted cryptographic key using the biometrically protected key; and
using the decrypted cryptographic key to decrypt the encrypted data or to validate the signature.

12. The computer-implemented method of claim 11, wherein the cryptographic key is a temporary key.

13. The computer-implemented method of claim 11, wherein the cryptographic key is a permanent key.

14. The computer-implemented method of claim 11, wherein the encrypted data is stored on the computing device.

15. The computer-implemented method of claim 11, wherein the encrypted data is stored in a location remote from the computing device.

16. The computer-implemented method of claim 11, wherein the accessing the encrypted cryptographic key is performed based on the application receiving a request.

17. The computer-implemented method of claim 11, wherein the accessing the encrypted cryptographic key is performed based on the application attempting to communicate with a server or a device.

18. The computer-implemented method of claim 11, wherein the accessing the encrypted cryptographic key is performed based on the application attempting to perform a scheduled task.

19. The computer-implemented method of claim 11, wherein the accessing the encrypted cryptographic key is performed based on a timer associated with the application.

20. The computer-implemented method of claim 11, wherein the accessing the encrypted cryptographic key is performed based on a security policy external to the application.
